(19) United States
(12) Patent Application Publication
(10) Pub. No.: US 2023/0206702 A1
(43) Pub. Date: Jun. 29, 2023

(54) DEVICE FOR VEHICLE MONITORING AND SYSTEM INCLUDING SAME

(71) Applicant: APPY RISK TECHNOLOGIES LIMITED, Cheshire (GB)

(72) Inventors: William Ben MINERS, Guelph (CA); Peter FINCH, Cheshire (GB); Jason Rae MIDDLETON, Lancashire (GB)

(73) Assignee: APPY RISK TECHNOLOGIES LIMITED, Cheshire (GB)

(21) Appl. No.: 17/928,467

(22) PCT Filed: May 28, 2021
(86) PCT No.: PCT/GB2021/051314

§ 371 Date: Nov. 29, 2022

(30) Foreign Application Priority Data
May 29, 2020 (GB) 2008105.5

(51) Int. Cl. G07C 5/08

(52) U.S. Cl. CPC G07C 5/08

(57) ABSTRACT

An information capture device for vehicle monitoring, the device including an at least one broad-spectrum vibration sensor to capture input information in relation to at least one measurable parameter relating to the vehicle is provided. A system including the information capture device and a portable computing device such as a smartphone, tablet or the like and/or a remoted server for analysis of the captured information is also disclosed.

### TECHNICAL FIELD OF THE INVENTION

The present invention relates generally to the monitoring of a vehicle. In particular, but not exclusively, the invention concerns a device for monitoring or assessing ambient conditions and/or dynamic vehicle monitoring.

### BACKGROUND TO THE INVENTION

Assessing dynamic vehicle behaviour is important for environmental, societal, and individual health and safety. Observing vehicle dynamics enables potential vehicle health issues to be identified early through changes in vehicle performance and vibrations. Solving vehicle health issues early improves both vehicle efficiency and environmental impact. The same vehicle dynamics are also valuable to identify risky driving behaviours and coach drivers with targeted, actionable feedback to modify future driver behaviour, reducing the probability for the driver to cause a future crash impacting the health and safety of both the driver and other travellers sharing our transportation networks.

Technologies to measure vehicle dynamics include accelerometers and gyroscopes embedded within a telematics control unit within the vehicle, either built into the vehicle or connected to the vehicle as an aftermarket device. While telematics control units are important and provide rich information to measure vehicle dynamics, they are not always practical in scenarios where the cost of installation and/or the cost of the additional hardware components is not commercially justifiable, or where installation flexibility is required.

Sensors within mobile telephones are often used to help minimize or eliminate additional in-vehicle hardware costs. Mobile telephone sensors can provide rich information about the mobility of individuals, and provide good proxies for high level vehicle movements including travel routes, vehicle speed, and manoeuvres. Unfortunately, mobile telephone sensors have significant limitations, including
1. Initial trip detection timing is slower using a mobile telephone than with in-vehicle hardware. Since the mobile telephone is battery-powered, techniques are required to adaptively manage power on the telephone, resulting in an inherent delay in detecting the start of each trip.
2. The mobile telephone is not a device that is intended to capture high-quality vehicle dynamics information. Although the components provided in a mobile telephone such as the microphone, the display, the accelerometer and gyroscope and the like are always increasing in quality, the components in a mobile telephone are, by their nature, multipurpose components. Further, given the treatment that a mobile telephone receives, the components are not precision instruments. This can introduce uncertainty and poor signal-to-noise ratios when considering the mobile telephone sensors as proxies for high precision vehicle dynamics.

Aftermarket, battery-operated or self-powered devices are available to help solve some of the limitations using the mobile telephone. These devices are designed to be affixed to the vehicle by the end-user, and typically include a short-range wireless mechanism between the device and a mobile telephone. These self-powered devices with some form of short-range wireless communication are sometimes called ‘tags’, ‘beacons’, or IoT/network-enabled vehicle devices. In their simplest form, these devices help improve the accuracy of the non-deterministic methods to associate mobile telephone data with a known vehicle by broadcasting a unique identifier for the mobile telephone to observe and include as part of the trip information captured by the telephone. In more sophisticated devices, an accelerometer is included to help provide more consistent vehicle-centric accelerometer measurements to augment mobile telephone measurements.

Unfortunately, while device sensors can be high quality, the installation location by the end-user is still uncontrolled and often results in the tag or device being thrown into the most convenient location, usually the centre console or glove-box. This occurs even when instructions are provided to affix the device to the windscreen or another rigid surface within the vehicle.

Embodiments of the invention seek to at least partially overcome or ameliorate any one or more of the abovementioned disadvantages or provide the consumer with a useful or commercial choice.

### SUMMARY OF THE INVENTION

According to a first aspect of the invention there is provided an information capture device for vehicle monitoring, the device comprising a broad-spectrum sensing device to capture input information in relation to at least one measurable parameter relating to the vehicle.

Providing at least one broad spectrum sensing device allows the device to capture information in relation to vibrations which are produced by the vehicle, and also events that occur involving the vehicle, inside the vehicle and outside the vehicle. The present invention may also include a methodology, typically embodied in a computer program that allows analysis and categorisation of one or more captured vibrations to identify one or more events.

According to a second aspect of the invention there is provided a method of monitoring a vehicle, the method comprising the steps of fixing at least one broad spectrum vibration sensor relative to the vehicle, capturing information in relation to at least one measurable parameter relating to the vehicle using the at least one broad spectrum vibration sensor and analysing the captured information to in relation to the at least one measurable parameter to identify occurrence of at least one event in relation to the vehicle.

The broad-spectrum sensing device may comprise a broad-spectrum vibration sensor. A single broad-spectrum sensor may be provided. More than one sensor may be provided. If more than one sensor is provided, the more than one sensor will preferably have complementary capture frequency bands.

Without wishing to be limited by theory, vibration is a mechanical phenomenon whereby oscillations occur about an equilibrium point. The oscillations may be periodic, such as the motion of a pendulum, or random, such as the movement of a tire on a gravel road and/or may include elements of both periodic and random vibration(s).

Vibration can be desirable: for example, the motion of a tuning fork, the reed in a woodwind instrument or harmonica, a mobile telephone, or the cone of a loudspeaker.

In many cases, however, vibration is undesirable, originating in wasted energy through the creation of unwanted sound. For example, the vibrational motions of engines or mechanical devices or components in a vehicle in operation are typically unwanted. Such vibrations can be caused by imbalances in the rotating parts, uneven friction, or the meshing of gear teeth. As such, analysis of the characteristics of a vibration can lead to identification of its cause.

Further, sound waves and/or pressure waves can be generated by vibrating structures.

As such, analysis of the characteristics of vibration(s) captured by the at least one broad-spectrum vibration sensor can lead to identification of its cause. As such, analysis of the characteristics of one or more sound waves and/or pressure waves captured by the at least one broad-spectrum vibration sensor can lead to identification of its cause.

The vehicle in which the device will normally be used is preferably a land vehicle. Typically, the land vehicle will be a road vehicle such as an automobile or car, bus, truck or the like.

The at least one broad spectrum vibration sensor device may be configured to capture acoustic information within one or more cabin area of a vehicle (configured to allow occupants to travel therein) to allow identification of events in relation to at least one occupant.

In the context of the present description, the phrase ‘vehicle monitoring’ may include monitoring of the vehicle itself and/or monitoring of events which occur in the vehicle and/or monitoring of (external) events which occur involve the vehicle.

In use, the information capture device will preferably be mounted in/on the vehicle but independently of the vehicle so that the information capture device is not reliant on any of the vehicle's systems for operation. Preferably, this will allow the information capture device to capture information in relation to the vehicle because the information capture device will preferably be mounted in/on the vehicle and also information which is not related to the operation of the vehicle.

The information capture device is preferably a self-powered device. The information capture device will preferably comprise at least one power supply.

The information capture device typically comprises an external housing. The external housing will normally contain any components of the device.

The information capture device may capture information regarding acoustics within a cabin or interior volume of the vehicle. Acoustic information may include speech or other sound(s) related to the occupants of the vehicle. Acoustic information may allow identification of events such as any one or more doors opening and/or closing or the engagement of a seat belt being properly fastened.

The information capture device may capture information regarding the operation and/or condition of the vehicle. This may be achieved through the capture of vibration information and/or acoustic information.

The captured information is preferably analysed to determine the meaning of any one or more portions of captured information. The analysis will typically be undertaken on a computer device or network. The computer device or network will normally operate at least one vibration and/or acoustic analysis software program to categorise captured vibration and/or acoustic information in order to identify at least one event signified by the captured vibration and/or acoustic information. The least one vibration and/or acoustic analysis software program will typically be trained to improve the detection and classification accuracy of events. The training may involve using frequency domain analysis and/or pattern recognition algorithms to identify previously trained patterns of vehicle events.

The at least one broad spectrum vibration sensor may be a multi-axis sensor. Typically, at least one broad spectrum vibration sensor will be a 3-axis sensor. More than one at least one broad spectrum vibration sensor having a single and/or dual axis operation may be provided.

The broad-spectrum vibration sensor bandwidth may differ in different directions. For example, a preferred analogue broad-spectrum vibration sensor device, the ADXL335 Accelerometer. This device has a 0.5-550 Hz vertical bandwidth and 0.5-1600 Hz horizontal bandwidth. This broad-spectrum accelerometer may capture low-frequency audio spectrum (300-1600 Hz) information. A microphone sensor may be provided to capture higher frequency audible information up to approximately 20000 Hz and possibly above this frequency.

The capture range of the at least one broad-spectrum sensor may not be continuous. The at least one broad-spectrum sensor may have a low frequency capture range adapted to capturing information regarding the operation of the vehicle. The at least one broad-spectrum sensor may have a higher frequency capture range adapted to capturing information in relation to acoustic events relating to or within the vehicle.

A broad-spectrum sensor will preferably have a low frequency capture range (0.5-550 Hz). This can be important to observe engine and road vibrations, where an engine running at 3000 RPM produces a signal of approximately 50 Hz, with road conditions typically having at least one lower frequency (lower on average) and vehicle vibrations typically having at least one higher frequency (higher on average). A higher frequency response in the horizontal plane is valuable to measure not only crash dynamics and the signature of vehicle doors opening and closing, but also low-frequency audio spectrum (300-1600 Hz) information even without a secondary dedicated microphone sensor.

The broad-spectrum sensor may have an information capture range of between 0.5 Hz to approximately 23000 Hz. The broad-spectrum sensor may have an infrasonic information capture range of up to 20 Hz. The broad-spectrum sensor may have an information capture range of between 20 Hz and approximately 23000 Hz. A single broad-spectrum sensor may be provided to capture information over the range. More than one broad-spectrum sensor may be provided to capture information over different portions of the range. The range need not be continuous.

The information capture device may comprise at least one communication device to send and/or receive information.

The at least one broad spectrum vibration sensor may be provided to capture input information in relation to at least one measurable parameter relating to vehicle dynamics.

The at least one broad spectrum vibration sensor may be provided to capture input information in relation to at least one measurable parameter relating to conditions within the vehicle or outside the vehicle.

The at least one broad spectrum vibration sensor may be provided to capture input information in relation to at least one measurable parameter relating to events occurring within the vehicle or outside the vehicle.

The at least one broad spectrum vibration sensor may be provided to capture input information in relation to at least one measurable parameter relating to occupant entry to and/or exit from the vehicle.

The information capture device may capture information substantially continuously from the or each sensor.

The information capture device may capture information at a number of spaced apart timesteps and stores captured information from the or each at least one sensor from an increased number of timesteps before, during, and after an event using at least one circular buffer with at least one configurable duration and at least one configurable timestep frequency.

In the present description, directions such as front, rear, sides, up and down are in respect of the use position of the device and are preferably determined with reference to the vehicle within which the device is used.

The device preferably includes an external housing with at least one sidewall. The external housing will typically contain the components of the device. In some configurations, one or more sensors or portion(s) thereof may extend from the housing.

The housing will preferably comprise at least one opening in at least one sidewall thereof.

The housing (or any part of the housing) may be manufactured from any one or more materials suitable for the application. One or more plastic materials will normally be used. The material(s) used will preferably be UV resistant given that the device will typically be located in an exposed position on the vehicle dashboard.

One or more apertures or openings may be provided in one or more of the housing portions, through the at least one sidewall. One or more apertures may be located in a recess in the housing.

One or more aperture or opening may be provided in a base wall of the housing. The base wall will typically be located adjacent to the dashboard of the vehicle in which the device is located. Any such one or more aperture or opening will typically allow more directed capture of vehicle specific information (such as changes in the operation of the vehicle, for example, engine vibration, suspension vibration of the like) through juxtaposition of the one or more aperture or opening with the dashboard. Any such aperture or opening will take advantage of the phenomenon that sound or vibration typically travels better and/or faster and/or more completely through a solid medium such as through the dashboard and therefore may be transmitted more efficiently for capture at the underside of the device.

One or more aperture or opening may be provided in an upper wall and/or any one or more of the at least one side wall of the housing. Any such aperture or opening (which does not directly face the dashboard) will typically allow capture of information relating to changes or situations occurring within the vehicle (as opposed to changes in the operation of the vehicle). One or more aperture or opening may be located to capture information to capture direction information as well. For example, any such aperture or opening is more likely to allow the capture of better-quality information relating to occupant noise and may be capable of capturing directionality information as well that could allow the number of occupants to be more accurately determined as well as seating location within the vehicle.

Directionality of incident vibrations can typically only be captured if the orientation of the information capture device is known. Therefore, in use, the information capture device will typically be installed in the vehicle ins a known orientation. One simple way in this may be achieved is to provide a shaped housing to provide an exterior contour which is at least partially wedge-shaped. An at least partially wedge-shaped housing is typically optimized to match an interior contour within the vehicle formed between the underside of a lower part of a vehicle windscreen and an upper side of the (front or rear) dashboard in a vehicle.

Any aperture or opening in the housing of the device will typically also allow ventilation of internal components of the device.

The device of the present invention is preferably provided with at least one internal power supply. The provision of at least one internal power supply will allow the device to be independent of the vehicle power supply. Normally, a single power supply is provided although in some conditions a primary power supply and a backup or secondary power supply may be provided. The power supply will typically be or include one or more batteries. Any battery maybe rechargeable in situ. Any battery may be removable and/or replaceable.

The device of the present invention preferably includes at least one communication device. The device of the present invention may be a part of a system in which the device captures information and transmits the captured information to a remote location (in the same vehicle or to outside the vehicle). Preferably the at least one communication device is or includes a short-range wireless transceiver. A short-wave wireless transceiver can transmit to a personal computing device such as a smartphone or tablet or similar. A smartphone or tablet or similar may process the information thereon and/or may transmit information (raw and/or processed information) to a further remote location or server for example.

Any communication standard may be used including any one or more of Bluetooth®, WiFi®, NFC, radio, optical or similar. More than one communication device may be provided to allow different (and separate) communication pathways to be used for the same device. There may be advantages to providing multiple, independent communication pathways such as separation of captured information from updates or instructions to the device.

The information capture device preferably includes at least one broad spectrum vibration sensor to capture input information in relation to at least one measurable parameter relating to the vehicle. Typically, the device will include a number of sensors, preferably configured to capture different types of information. The information will typically be captured contemporaneously. The advantage of capture of different types of information contemporaneously is that analysis of different types of information captured contemporaneously may reveal more than analysis of a single type of information.

The device may include one or more accelerometer preferably used to detect the orientation of the device. An accelerometer typically measures linear acceleration of movement.

The device may include one or more gyroscope. A gyroscope preferably adds an additional dimension to information supplied by the preferred accelerometer, by tracking rotation or twist. A gyroscope typically measures angular rotational velocity.

An accelerometer will typically measure the directional movement of a device but will normally not be able to resolve its lateral orientation or tilt during that movement accurately unless a gyroscope is there to fill in that information.

A multi-axis accelerometer may be combined with a multi-axis gyroscope to provide information in relation to the orientation of the device that is both clean and responsive in the same time.

The device may include one or more magnetometer, typically used to detect the Earth's magnetic field along three perpendicular axes X, Y and Z. As such, a magnetometer can detect rotational information in relation to the device. In addition to general rotational information, the magnetometer can detect the relative orientation of the device relative to the Earth's magnetic north. A magnetometer is preferably used to provide digital compass functionality to determined orientation of the device in relation to the Earth's magnetic field.

The device may include one or more optical sensor to measure quantity of light. One or more optical sensor can be used to capture information as to the quantity of light incident on the device. More than one optical sensor may be provided oriented in different directions. This may allow directionality of the light measurement to be determined.

The device may include one or more water sensor to detect moisture, most commonly mist, fog or rain. Any type of sensor may be used for this purpose. The one or more water sensor will preferably capture information about mist, fog or rain with reference to the windscreen of the vehicle in which the device is located. A sensor that projects infrared light into the windscreen may be used. The device may include a rain sensor such as an infrared sensor positioned relative to the housing so that the rain sensor may contact the windscreen when the device is positioned correctly in the vehicle.

One or more pressure sensors may be provided to capture information relating to external pressure.

As mentioned briefly above, the at least one broad spectrum vibration sensor may capture information in relation to at least one pressure wave. The at least one broad spectrum vibration sensor may typically capture information on variations/changes in pressure within the vehicle, particularly those which may indicate a particular event has taken place such as opening and closing a door of the vehicle for example.

The at least one broad spectrum vibration sensor may capture information relating to the level of sound within the vehicle and/or relating to the vehicle.

At least one broad spectrum vibration sensor mounted within the device preferably enables the device to characterize the level of potential internal acoustic distractions for the driver, including loud music or occupant noises.

The at least one broad spectrum vibration sensor will normally be mounted within the housing. Preferably, the one or more sound sensor/microphone will be mounted within the housing relative to one or more apertures or openings in a wall of the housing.

More than one broad spectrum vibration sensor may be provided to preferably cover a complementary spectrum extending into higher frequencies to improve the detection and classification of captured information.

Where more than one broad spectrum vibration sensor is provided, the sensor may be of the same type, different types or the same general type with different characteristics or operating parameters to capture one or more different (possibly overlapping) portions of the vibration spectrum.

For example, more than one accelerometer may be provided. An accelerometer to measure acceleration along only a single axis could be used to measure mechanical vibration levels. A triaxial accelerometer may be used to create a 3D vector of acceleration in the form of orthogonal components which accordingly allows determination of the type of vibration, such as lateral, transverse, or rotational.

One or more accelerometer may be provided with one or more microphones. One or more broad spectrum microphone may be used. This may allow the microphone to capture sounds but also allow other vibrations which are outside audible range to be captured.

The device and/or a system including the device may use frequency domain analysis and pattern recognition algorithms to identify previously trained patterns of vehicle impacts via sound captured by the microphone.

In the case of a vehicle collision, the device preferably stores a higher frequency set of information from all sensors before, during, and after the collision. This is typically achieved using circular buffers with configurable durations and frequencies.

The method that can be used to detect vehicle events can also be applied to vehicle damage detection or potential theft even if the vehicle is stationary, including glass break detection.

The at least one broad spectrum vibration sensor may be used to ascertain driver/occupant entry. This could be achieved through capture of any one or more of pressure information, sound information and/or vibration information. Contemporaneous capture of more than one type of information is preferred for greater accuracy in the categorisation of the occurrence of an event. This in turn can be used to measure for example, the time between driver entry and vehicle ignition start or vehicle motion, as a proxy for the state of mind of the driver (on the basis that a driver than enters and then starts the vehicle may be more aware or more focussed than a driver that waits a significant period after entry to start the vehicle).

Use of door open/close detection can also be used to estimate vehicle occupancy for other reasons such as (but not limited to) risk assessment and occupancy information.

More than at least one broad spectrum vibration sensor may be provided in different locations within the information capture device. For example, a first broad spectrum vibration sensor may be provided to capture vibration information relating to vehicle operation and/or performance. The first broad-spectrum vibration sensor may be located towards the base wall of the device. The first broad-spectrum vibration sensor may be oriented to capture vibrations transmitted from an/or through the dashboard. At least one second first broad-spectrum vibration sensor may be provided to capture vibration information relating to in-cabin vibrations (typically those caused by occupants as opposed to those caused by, emanating from or through (such as vibration caused by the vehicle operation or road conditions or the like) the vehicle itself).

The device may include one or more proximity sensor to detect when an object such as a mobile telephone or tablet for example, is proximate to the device. This functionality may be used to initialise the capture of information by the device. This functionality may be used to prepare components of a mobile telephone or tablet for example. The device can utilise proximity information to use adaptive power management techniques to deliver years of operation without user intervention. The start of each trip may be automatically detected in a timely manner by detecting the vehicle door opening and closing as an initial pre-trip cue, that is, the device can exit sleep mode upon detecting the vehicle door opening and closing. This approach can ensure any mobile telephone that might be present as a part of a system, can enable its GNSS subsystems and/or other sensors, so they are ready by the time the vehicle ignition is turned on, delivering more complete trip information than would be possible using information which is conventionally gathered using a mobile telephone only. This approach can provide valuable pre-trip information about the time between the driver entering the vehicle and the time the vehicle ignition is enabled, that is not available from any known aftermarket or professionally-fitted telematics hardware. One simple mechanism for this detection may be to detect when a portable computing moves into or is within Bluetooth range (or other similar communication protocol), for example.

Use of information captured from more than one sensor (particularly contemporaneous information from different sensors) can lead to a reduction in false-positive situations such as using contemporaneously captured information from more than one sensor to cross-check for anomalies. Another situation when information from an accelerometer and acoustic information may be used is in the classification of collisions and glass break for example.

The device may include one or more real-time clock. The device may utilise an external device such as a smartphone or tablet for example to forward information captured to a remote location. The device may operate in a store and forward mode until the device detects the presence of an appropriate external device or is contacted for the captured information that has been stored thereon. When the external device is not present, the device preferably continues to capture information in a store-and-forward manner.

The device may include one or more information storage devices onboard the device to store information until the information can be forwarded. The information storage will preferably be electronic information storage. The electronic information storage will preferably be non-volatile storage.

The information captured will preferably be timestamped on the device using information from the preferred on-board real-time-clock. The timestamp is preferably encoded with the information captured. By encoding this additional information, the information will typically become more valuable in auditing, forensic, insurance claims, or other high-integrity use cases.

The device will normally have an electronic operating system operating on an onboard processor. The electronic operating system will normally be or include a software application which will preferably control the operating of the components of the device.

The device will preferably further comprise a wireless transceiver. The transceiver will preferably be a short-range transceiver which can be associated (wirelessly) with a long-range transceiver to provide the preferred store and forward functionality with the short-range transceiver is associated with the device.

Another consideration for the information capture device in the context of the invention the mechanism used to mount the device within the vehicle. Typical mounting methods include:
Magnetic
Adhesive
Stud mount

Stud mounting is by far the best mounting technique for capture of information relating to transmission of vibration by or through the vehicle. The attachment methods will normally affect the measurable frequency of the at least one broad spectrum vibration sensor. Generally speaking, the looser the connection, the lower the measurable frequency limit. The addition of mass to the device, such as an adhesive or magnetic mounting base, may lower the resonant frequency, which may affect the accuracy and limits of the at least one broad spectrum vibration sensor usable frequency range, particularly if the at least one broad spectrum vibration sensor is an accelerometer. Mounting using an adhesive is preferred as it delivers the optimum usable frequency range without requiring damage to the mounting surface which may be found with stud mounting.

In another form, the present invention may comprise a system for vehicle event characterisation, the system including an in-vehicle information capture device having any one or more of the features describe hereinbefore and a portable computing device including at least one communication device to receive captured information from the in-vehicle information capture device and at least one information storage device.

Provision of a system including an in-vehicle information capture device and a portable computing device will preferably allow the in-vehicle information capture device to operate in-vehicle when needed (such as for example when the portable computing device is not in range of the device or has little or no outgoing service) in a store and forward mode and also in a continuous mode when possible (such as for example when the portable computing device is in range of the device and has sufficient outgoing service). The in-vehicle information capture device may provide captured information to a remote location through the portable computing device, preferably using the communication components of the portable computing device, which allows the device to be simplified as much as possible as it does not require complex and/or powerful onboard communications components.

The portable computing device may be a smartphone or tablet or other portable computing device with sufficiently powerful communications components to undertake long range communications. The portable computing device will normally include a short-range wireless transceiver (this may be the same transceiver as the long-range transceiver or a separate unit).

Typically, the portable computing device may include at least one on-board accelerometer.

Typically, the portable computing device may include at least one on-board gyroscope.

Typically, the portable computing device may include at least one on-board magnetometer.

Typically, the portable computing device may include at least one on-board navigation component/system. Normally, a smartphone or tablet, for example, will include a Global Navigation Satellite System (GNSS) component.

Typically, the portable computing device may include at least one on-board storage component. Preferably the at least one storage component will be or include electronic storage. The electronic storage will typically be non-volatile storage.

Typically, the portable computing device may include at least one on-board long-range wireless transceiver. The long-range wireless transceiver may be configured to send and receive information to and from an associated short-range transceiver, such as from the device. The long-range wireless transceiver may be configured to send and receive information to and from an associated remote location.

The portable computing device will normally have an electronic operating system operating on an onboard processor. The electronic operating system will normally be or include a software application which will preferably control the operating of the components of the portable computing device. A secondary software application may be provided for operation on the portable computing device to interface with the in-vehicle information capture device. Preferably the secondary software application interfaces with a preferred software application operating on the in-vehicle information capture device. The secondary software application may interface with a server software application operating on a remote server.

The system may preferably further comprise a server associated with at least one communication device to receive captured information from the device and a processor operating at least one software program to analyse the information captured by the in-vehicle information capture device.

The server may receive the captured information directly from the in-vehicle information capture device. The server may receive the captured information from the in-vehicle information capture device via the portable computing device.

Typically, only minimal processing will take place on the in-vehicle information capture device. Preferably, only information processing that is required to ensure the encoding of the real-time clock information with the captured information and/or to maintain information integrity and/or undertake data compression if needed, will occur on the in-vehicle information capture device.

Preferably, the bulk of the processing of the captured information will occur at the server. Analysis of any captured information will preferably occur at the server. Long term storage of captured information (and/or any analysis thereof) will preferably occur in storage associated with the server.

There may be scenarios where some analysis must occur locally in the portable computing device or in-vehicle information capture device (and/or distributed) due to limited communication link performance.

The captured information can be used to identify events that occur within or in relation to the vehicle.

The captured information can be analysed to identify events based on characteristic vibration(s) and/or noise. A system utilising an information capture device can be used to detect and build patterns. Captured information representing vehicle performance as quantified by vehicle vibrations and/or noise at given speeds, during specific rates of acceleration, braking, and on known road conditions can be indexed and once captured, can be used to compare to live or captured information. As the vehicle continues to be used, deviations from the baseline can be monitored to help detect potential imbalanced wheels, alignment issues, or potential engine issues. These issues can be identified by comparing changes in the mechanical and acoustic information measured from the vehicle when driven in the same speed/acceleration/braking/road conditions.

In addition, captured information may be used in detection of vehicle collisions and assessing occupant risk to improve safety.

In another aspect, the present invention may comprise a vehicle with at least one information capture device having the essential features and any one or more of the preferred features described above fitted thereto.

### DETAILED DESCRIPTION OF THE INVENTION

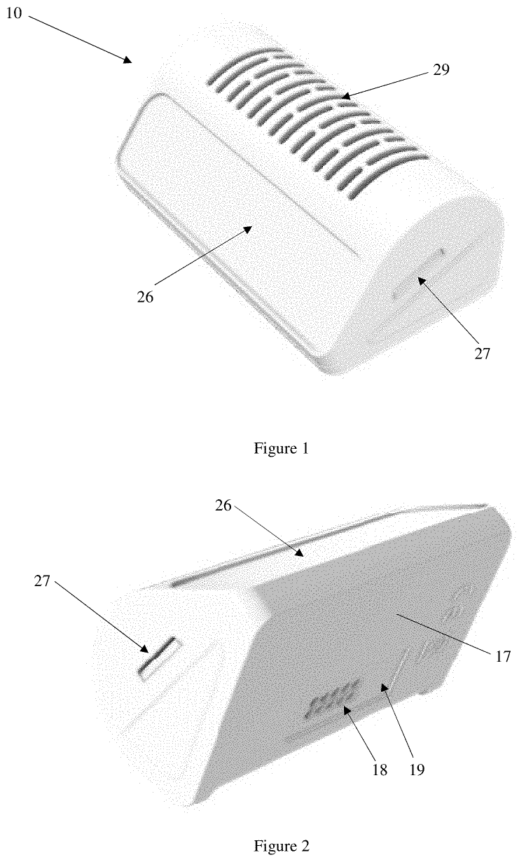

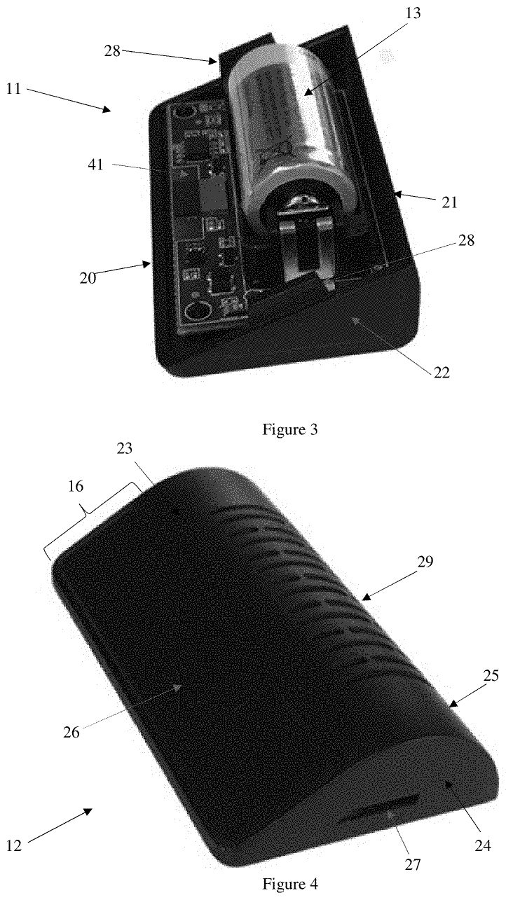

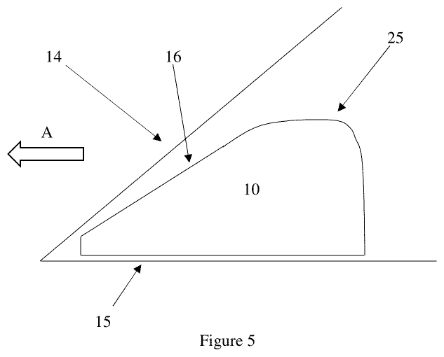

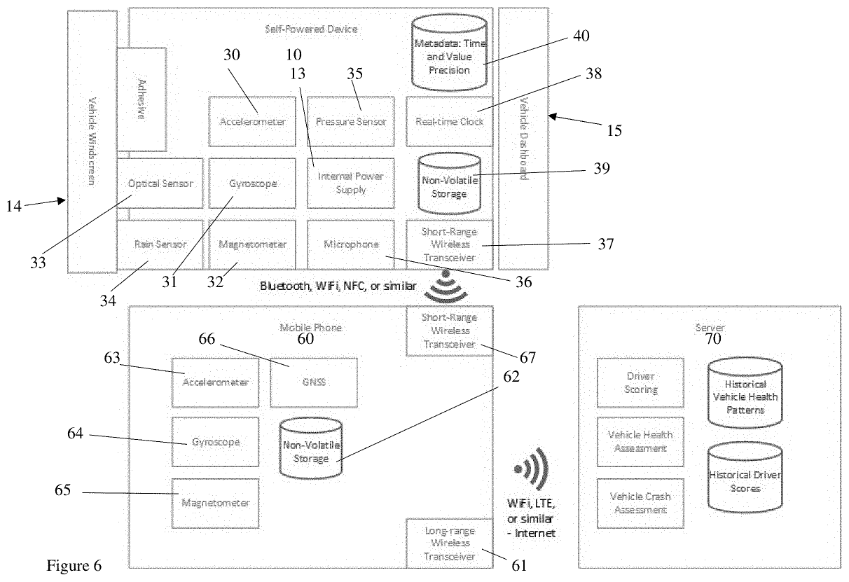

In order that the invention may be more clearly understood one or more embodiments thereof will now be described, by way of example only, with reference to the accompanying drawings, of which:
FIG. 1 is an isometric view of an information capture device for vehicle monitoring according to an embodiment;
FIG. 2 is an isometric view from the underside of the device illustrated in FIG. 1;
FIG. 3 is an isometric view of an information capture device for vehicle monitoring with the upper housing portion removed;
FIG. 4 is an isometric view of the upper housing portion corresponding to that removed in FIG. 3;
FIG. 5 is a schematic side elevation view of an information capture device for vehicle monitoring according to an embodiment in a use position relative to a vehicle dash and windscreen;
FIG. 6 is a schematic illustration of a system including an information capture device for vehicle monitoring according to an embodiment.

With reference to the accompanying figures, an information capture device 10 for vehicle monitoring is illustrated in FIGS. 1 to 4. The illustrated device 10 comprises a multi-part external housing (illustrated assembled in FIGS. 1 and 2 and separated in FIGS. 3 and 4). The illustrated housing includes a lower portion 11 (illustrated in FIG. 3 in particular) and an upper portion 12 (illustrated in FIG. 4 in particular).

The external housing has a number of sidewalls which together define a wedge-shaped portion of the external housing. At least one opening is provided in at least one sidewall of the eternal housing. Internally, the device 10 includes an internal power supply, in the form of a battery 13 as shown in FIG. 3, at least one communication device, and at least one sensor to capture input information in relation to at least one measurable parameter relating to the vehicle (not shown).

A schematic view of the preferred location and orientation of the device illustrated in FIGS. 1 to 4 is shown in FIG. 5. FIG. 5 shows the device 10 in the orientation in which it is intended to be used with respect to a forward (or rear) dash 15 and a forward (or rear) windscreen 14.

In that Figure, the device is located at the base of the forward windscreen 14 of a vehicle, mounted relative to an upper side of the dashboard 15 of the vehicle. The vehicle will normally travel in a forward direction (signified by the arrow A).

As illustrated, the housing is preferably wedge-shaped at a forward side of the device 10. As shown, the illustrated wedge-shaped housing of the device 10 includes a forward upper wall 16 which tapers downwardly at a forward end such that the thickness of the device is less at the forward end of the device and greater at the rearward end as shown. The angle of the forward upper wall 16 of the wedge-shaped housing is preferably similar to the angle of the windscreen 14 of the vehicle relative to an upper surface of the dashboard 15. Ideally, the angle of the forward upper wall 16 will correspond to the angle of the windscreen 14 but there is variation in the angle of the windscreen relative to the dashboard between OEM manufacturers and vehicle models.

The housing portions shown are manufactured from plastic materials. The material(s) used will preferably be UV resistant given that the device 10 will typically be located in an exposed position on the vehicle dashboard as shown in FIG. 5.

The housing illustrated is a multipart housing. Normally, two housing portions are provided, namely a lower housing portion 11 and an upper housing portion or cover 12, as illustrated in FIGS. 3 and 4 respectively.

The lower housing portion will normally include a base wall 17. The base wall 17 of the illustrated embodiments is planar but may be a shaped or contoured lower surface to correspond to an upper surface of the dashboard 15.

The underside of the base wall 17 of the device may be provided with a location assistance or guidance structure or configuration. A recess may be provided on the underside of the base wall 17. Preferably, double sided adhesive tape is located in the recess and used to attach the device 10 relative to the vehicle, guided by the wedge shape.

A set of apertures or openings 18 is provided through the base wall of the device. In the embodiment illustrated in FIG. 2, the apertures 18 are located in a recess 19 in the housing to space the openings from the dashboard 15. This may aid in the capture of sound and/or vibration from the dashboard 15.

These openings 18 will typically allow more directed capture of vehicle specific information (such as changes in the operation of the vehicle, for example, engine vibration and/or noise, suspension vibration etc) through the juxtaposition of the openings 18 relative to the dashboard 15.

As illustrated, a rectangular shaped housing includes at least three and preferably four sidewalls extending upwardly from the base wall. Each of the sidewalls extend from the base wall 17 substantially perpendicularly. Each sidewall extends from the base wall 17 at a peripheral location of the base wall 17.

As illustrated in FIG. 3 in particular, a forward side wall 20 is provided and is shorter or lower than a taller rear sidewall 21. The lateral sidewalls or end walls 22 have an angled upper edge extending between an upper edge of the forward side wall 20 and an upper edge of the rear side wall 21.

As shown in FIG. 4, the upper housing portion 12 includes a top wall 23. A pair of end walls 24 depend from the top wall 23. The top wall 23 has an arcuate rear portion 25 and a planar angled forward portion 16. Shaped lateral side walls or end walls 24 are provided to close the lateral sides or ends of the upper housing portion 12.

As shown in FIG. 4, a recess 26 is provided in an upper side of the angled forward portion 16. Double side adhesive tape (not shown) may be located in the recess 26 to attach the device relative to the windscreen 14.

Preferably, when the upper housing portion 12 is attached to the lower housing portion 11, a generally wedge-shaped housing is formed, such as that illustrated in FIGS. 1 and 2.

The upper housing portion 12 of the illustrated embodiments is releasably attachable relative to the lower housing portion 11. Removal of the upper housing portion 12 from the lower housing portion 11 will typically allow access to the internal components of the housing. In an embodiment, the upper housing 12 attaches to the lower housing portion 11 using a releasable attachment, with a snap fit assembly preferred.

In the illustrated embodiments, an opening is provided in each of the shaped lateral side walls or end walls 24 of the upper housing portion 12. Typically, a single elongate slot opening 27 is provided in each lateral side wall or end walls 24.

A resiliently deformable arm 28 is provided relative to each of the lateral sidewalls 22 of the lower housing portion 11. In the illustrated embodiment, each resiliently deformable arm 28 is provided with an angled surface which in use, will abut the lower edge of the shaped lateral side walls 24 of the upper housing portion 12 as the upper housing portion 12 is forced downwardly to attach the upper housing portion 12 to the lower housing portion 11. The angled surface will typically force temporary deformation of the respective resiliently deformable arm 28 inwardly.

An abutment shoulder or surface is provided on each resiliently deformable arm 28. The resiliently deformable arm 28 will preferably be deformed until the abutment shoulder or surface is aligned with an edge of the respective elongate slot opening 27 in the shaped lateral side wall 22 of the upper housing portion 12, engaging the edge to lock the upper housing portion 12 relative to the lower housing portion 11.

A user may force the deformation of the resiliently deformable arm 28 inwardly in order to clear the abutment shoulder or surface from edge of the respective elongate slot opening 27 in the shaped lateral side walls or end walls 22 of the upper housing portion 12, allowing separation of the upper housing portion 12 from the lower housing portion 11.

The upper housing portion 12 and/or lower housing portion 11 may be provided with one or more optically transparent portions. At least one optically transparent portion is preferably provided at or towards a forward side of the upper housing portion. A part of the preferred angled planar top wall is preferably optically transparent. The provision of such an optically transparent portion will typically allow the use of an optical sensor in the device 10 to capture information on at least light conditions. For example, a forwardly oriented light sensor may be provided to detect approaching headlights of oncoming traffic. An optical sensor could also be used to detect ambient light levels outside the vehicle which can be analysed for a variety of conditions/situations such as when the vehicle enters a tunnel or a carpark for example (a rapid reduction in light) as opposed to night falling (a more gradual reduction of light).

A number of openings 29 are provided in the rear portion 25 of the upper wall 23. These opening 28 will typically allow more directed capture information relating to changes or situations occurring within the vehicle (as opposed to changes in the operation of the vehicle normally captured through the openings 18 through the base wall). For example, opening 29 are more likely to allow the capture of better-quality information relating to occupant noise and may be capable of capturing directionality information as well that could allow the number of occupants to be more accurately determined, as well as seating location of occupants within the vehicle.

Any aperture or opening 18, 29 in the housing of the device 10 will typically also allow ventilation of internal components of the device 10.

The provision of the battery 13 on board the device 10 allows the device 10 to be independent of the vehicle power supply. The illustrated battery is removable and/or replaceable but any battery may be rechargeable in situ. Where the power source is provided as a battery 13 as shown, the battery 13 is typically provided at an upper part of the lower housing 11 so as to be accessible when the upper housing portion 12 is removed from the lower housing portion 11.

As will be explained further below, the device 10 may be a part of a system in which the device 10 captures information and transmits the captured information to a remote location (in the same vehicle or to outside the vehicle). Preferably, the at least one communication device is or includes a short-range wireless transceiver. A short-wave wireless transceiver can transmit to a personal computing device such as a smartphone 60 or tablet or similar as illustrated in FIG. 6. A smartphone 60 or tablet or similar may process the information thereon and/or may transmit information (raw and/or processed information) to a further remote location or server 70 for example, as illustrated in FIG. 7.

Any communication standard may be used including any one or more of Bluetooth®, WiFi®, NFC, radio, optical or similar. More than one communication device may be provided to allow different (and separate) communication pathways to be used for the same device 10. There may be advantages to providing multiple, independent communication pathways such as separation of captured information from updates or instructions relating to the operation of any one or more on board components of the device 10.

As shown in FIG. 6, the device 10 preferably includes a number of different sensors to capture input information in relation to measurable parameters relating to the vehicle. Typically, the device 10 includes a number of sensors configured to capture different types of information. The different types of information will typically be captured from the sensors contemporaneously. The advantage of capture of different types of information contemporaneously is that analysis of different types of information captured contemporaneously may reveal more than analysis of a single type of information.

As illustrated in FIG. 6, the device may include one or more accelerometer 30 preferably used to detect the orientation of the device, usually capturing information relating to the linear acceleration of movement.

As illustrated in FIG. 6, the device may include one or more gyroscope 31, to add an additional dimension to information supplied by the preferred accelerometer, by capturing information relating to angular rotational velocity.

The accelerometer 30 will typically measure the directional movement of a device but will normally not be able to resolve its lateral orientation or tilt during that movement accurately unless the gyroscope 31 is there to fill in that information.

A multi-axis accelerometer 30 may be combined with a multi-axis gyroscope 30 to provide information in relation to the orientation of the device 10 that is both clean and responsive in the same time.

As illustrated in FIG. 6, the device may include one or more magnetometer, 32 typically used to detect the Earth's magnetic field along three perpendicular axes X, Y and Z. As such, the magnetometer 32 can capture rotational information in relation to the device 10. In addition to general rotational information, the magnetometer 32 can detect the relative orientation of the device 10 relative to the Earth's magnetic north. The magnetometer 32 is preferably used to provide digital compass functionality to determined orientation of the device 10 in relation to the Earth's magnetic field.

As illustrated in FIG. 6, the device 10 may include one or more optical sensor 33 to measure quantity of light. More than one optical sensor 33 may be provided, oriented in different directions. The one or more optical sensor 33 may allow directionality of the light measurement to be determined.

As illustrated in FIG. 6, the device 10 may include one or more water sensor 34 to detect moisture, most commonly mist, fog or rain. Any type of sensor may be used for this purpose. The one or more water sensor will preferably capture information about mist, fog or rain with reference to the windscreen 14 of the vehicle in which the device 10 is located. A sensor that projects infrared light into the windscreen 14 may be used. In the embodiment illustrated in FIG. 6, the device 10 may include a rain sensor 34 such as an infrared sensor positioned relative to the housing so that the rain sensor 34 may contact the windscreen 14 when the device 10 is positioned correctly in the vehicle, as illustrated in FIG. 5.

As illustrated in FIG. 6, the device 10 may include one or more pressure sensor 35 to capture information regarding pressure inside the vehicle. The one or more pressure sensor 35 may typically capture variations/changes in pressure within the vehicle, particularly those which may indicate a particular event has taken place such as opening and closing a door of the vehicle for example. One or more pressure sensors may be provided to capture information relating to external pressure.

As illustrated in FIG. 6, the device 10 may include one or more broad spectrum microphones 36 to capture information relating to the level of vibration and/or sound within the vehicle and/or relating to the vehicle.

A microphone 36 mounted within the vehicle preferably enables the device 10 to characterize the level of potential internal acoustic distractions for the driver, including loud music or occupant noises. The one or more microphone 36 will normally be mounted within the housing. Preferably, the one or more microphones 36 will be mounted within the housing relative to one or more openings 18, 29 in a wall of the housing.

The microphone 36 preferably covers a complementary spectrum extending into higher frequencies than the accelerometer 30 to improve the detection and classification accuracy of vehicle events. The device/system may use frequency domain analysis and pattern recognition algorithms to identify previously trained patterns of vehicle events via sound captured by the microphone 36.

In the case of a vehicle collision, the device preferably stores a higher frequency set of information from all sensors before, during, and after the collision. This is typically achieved using circular buffers with configurable durations and frequencies.

The method that can be used to detect vehicle events can also be applied to vehicle damage detection or potential theft even if the vehicle is stationary, including glass break detection and/or collisions involving the vehicle.

The microphone 36 may be used to ascertain driver/occupant entry. This in turn can be used to measure for example, the time between driver entry and vehicle ignition start or vehicle motion, as a proxy for the state of mind of the driver (on the basis that a driver than enters and then starts the vehicle may be more aware or more focussed than a driver that waits a significant period after entry to start the vehicle.

Use of door open/close detection can also be used to estimate vehicle occupancy for other reasons such as (but not limited to) risk assessment and occupancy information for High Occupancy Vehicle (HOV)/High Occupancy Toll (HOT) lane qualification.

The device may include one or more vibration sensor to capture information relating to vibrations of the device. More than one vibration sensor may be provided. The broad spectrum microphone 36 may be used to capture vibration information.

As illustrated in FIG. 6, the device 10 may include one or more proximity sensor to detect when an object such as a mobile telephone or tablet for example, is proximate to the device. This functionality may be used to initialise the capture of information by the device. This functionality may be used to prepare components of a mobile telephone or tablet for example. The device can utilise proximity information to use adaptive power management techniques to deliver years of operation without user intervention. The start of each trip may be automatically detected in a timely manner by detecting the vehicle door opening and closing as an initial pre-trip cue, that is, the device can exit sleep mode upon detecting the vehicle door opening and closing. This approach can ensure any mobile phone that might be present as a part of a system, can enable its GNSS subsystems and/or other sensors, so they are ready by the time the vehicle ignition is turned on, delivering more complete trip information than would be possible using information which is conventionally gathered using a mobile telephone only. This approach can provide valuable pre-trip information about the time between the driver entering the vehicle and the time the vehicle ignition is enabled, that is not available from any known aftermarket or professionally-fitted telematics hardware. A short-range transceiver 37 may be used to detect the presence of a smartphone 60 for example using one or more of Bluetooth®, WiFi®, NFC or similar protocols.

Use of information captured from more than one sensor (particularly contemporaneous information from different sensors) can lead to a reduction in false-positive situations such as using contemporaneously captured accelerometer and acoustic information to cross-check for anomalies. Another situation when information from the accelerometer and acoustic information may be used is in the classification of collisions and glass break, for example.

As illustrated in FIG. 6, the device 10 may include a real-time clock 38. The device 10 may utilise an external device such as a smartphone 60 or tablet for example to forward information captured to a remote location. The device 10 may operate in a store and forward mode until the device 10 detects the presence of an appropriate external device such as the smartphone 60. When the external device 60 is not present, the device 10 preferably continues to capture all vehicle activity in a store-and-forward manner, temporarily storing the captured information in memory on the device 10 until an appropriate external device such as the smartphone 60 is detected and can be used to forward the captured information.

As illustrated in FIG. 6, the device 10 may include one or more information storage devices onboard the device 10 to store information until the information can be forwarded. The information storage will preferably be non-volatile electronic information storage 39.

The (preferably all) information captured by the device 10 will preferably be timestamped on the device 10. A timestamp from the real-time clock 38 is preferably encoded using metainformation 40 with the information captured. By encoding this additional information with the captured information, the information will typically become more valuable in auditing, forensic, insurance claims, or other high-integrity use cases.

The device 10 will normally have an electronic operating system operating on an onboard processor all mounted relative to a printed circuit board 41 such as that illustrated in FIG. 3. The electronic operating system will normally be or include a software application which will preferably control the operating of the components of the device 10.

As illustrated in FIG. 6, the device 10 will preferably further comprise a wireless transceiver 37. The transceiver 37 will preferably be a short-range transceiver which can be associated (wirelessly) with a long-range transceiver 61 to provide the preferred store and forward functionality.

In one implementation of the invention, the use of a commodity 3-axis MEMS based accelerometer combined with the defined shape provides the benefit of alignment between the (typical) asymmetrical characteristics of the 3 accelerometer axes in commodity sensors. In the specific case of the Analog Devices ADXL335, bandwidths can be selected to suit the application, with a range of 0.5 Hz to 1600 Hz for the X and Y axes, and a range of 0.5 Hz to 550 Hz for the Z axis. If the information capture device is installed in a known orientation for the installation of the device in the vehicle ensures that the accelerometer axes are aligned consistently between each vehicle and deliver consistent observations.

The human range of hearing is commonly given as 20 to 20,000 Hz. The at least one broad spectrum vibration sensor will preferably have a range from 0.5 Hz to at least 20,000 Hz. This will preferably give good cover over both the infrasonic ranges which are likely to more commonly relate to vehicle-originating vibrations and also the acoustic range of sounds that are audible to a human, such as speech and other sounds such as seatbelt engagement for example. More than one broad spectrum vibration sensor may be provided for different portions of the range.

The range of the at least one broad spectrum vibration sensor device may not be continuous. The at least one broad spectrum vibration sensor device may capture information in one or more particular ranges within a much broader overall range. For example,

The lower frequency range may be particularly important to observe engine and road vibrations, where for example, an engine running at 3000 RPM produces a 50 Hz signal, with road conditions typically at a lower frequency and vehicle vibrations causing higher frequency signals.

The higher frequency response in the horizontal plane of the Analog Devices ADXL335 device for example is valuable to measure not only crash dynamics and the signature of vehicle doors opening and closing, but also low-frequency audio spectrum (300-1600 Hz) information, even without a secondary dedicated microphone sensor.

Most of the spectrum supported by the combination of a 3-axis accelerometer and microphone can also be realized using a unified broad-spectrum sensor such as the ADXL1005 (0.5-23 kHz), or pairing the broad-spectrum sensor with a 2-axis conventional accelerometer.

A system for high precision ambient and dynamic vehicle assessment is illustrated in FIG. 6. The system illustrated in FIG. 6 includes an in-vehicle information capture device 10, a smartphone 60 including a communication device 61 to receive captured information from the in-vehicle information capture device 10 and at least one information storage device 62, and a server 70 associated with at least one communication device 61 to receive captured information from the device 10 and a processor operating at least one software program to analyse the information captured by the in-vehicle information capture device 10.

Provision of a system including an in-vehicle information capture device 10 and a smartphone 60 will preferably allow the device 10 to operate in-vehicle when needed (such as for example when the smartphone 60 is not in range of the device 10 or has little or no outgoing service) in a store and forward mode and also in a continuous mode when possible (such as for example when the smartphone 60 is in range of the device and has sufficient outgoing service). The device 10 may provide captured information to a remote location through the smartphone 60, preferably using the communication components of the smartphone 60, which allows the device 10 to be simplified as much as possible as it does not require complex and/or powerful onboard communications components.

The smartphone 60 used as an example within the system will typically be provided with sufficiently powerful communications components to undertake long range (or longer range than the device 10) communications. The smartphone 60 will normally include a short-range wireless transceiver 67 (this may be the same transceiver as the long-range transceiver 61 or a separate unit).

As is normal with smartphones 60, the smartphone 60 may include at least one on-board accelerometer 63, at least one on-board gyroscope 64, at least one on-board magnetometer 65 and at least one on-board navigation component/system 66. Normally, a smartphone 60 for example, will include a Global Navigation Satellite System (GNSS) component 66.

As illustrated in FIG. 6, the smartphone 60 may include at least one on-board non-volatile, electronic information storage component 62.

The long-range wireless transceiver may be configured to send and receive information to and from an associated remote location.

The smartphone 60 will normally have an electronic operating system operating on an onboard processor. The electronic operating system will normally be or include a software application which will preferably control the operating of the components of the smartphone 60. A secondary software application may be provided for operation on the smartphone 60 to interface with the device 10. Preferably the secondary software application interfaces with a software application operating on the device 10. The secondary software application may interface with a server software application operating on a remote server 70.

The server 70 may receive the captured information directly from the in-vehicle information capture device 10 but the embodiment illustrated in FIG. 6 has the server 70 receiving the captured information via the smartphone 60.

Typically, only minimal processing will take place on the in-vehicle information capture device 10. Preferably, only information processing that is required to ensure the encoding of the timestamp information with the captured information (and to maintain information integrity) will occur on the in-vehicle information capture device 10.

Preferably, the bulk of the processing of the captured information will occur at the server 70. Analysis of any captured information will preferably occur at the server 70. Long term storage of captured information (and/or any analysis thereof) will preferably occur in storage associated with the server 70.

As illustrated in FIG. 6, the server 70 can analyse the captured information to determine information relating to driver performance, vehicle health, vehicle events such as crashes, and store this information to track historical vehicle health patterns and historical driver performance.

The device 10 of the preferred embodiment includes high-precision sensors to measure vehicle dynamics, along with non-volatile storage to ensure vehicle activities are measured with or without a smartphone being present. A short-range wireless mechanism is used to communicate with a smartphone for both transferring vehicle dynamics information, and for secure software and configuration updates. Sensors typically include accelerometers along with gyroscopes, optical, acoustic, magnetometer/digital compass, barometer, and rain sensor options. An internal real-time-clock is also used to associate vehicle activities and events with specific times.

The device 10 preferably uses adaptive power management techniques to deliver years of operation without user intervention. The start of each trip is automatically detected in a timely manner by detecting the vehicle door opening and closing as an initial pre-trip cue. This approach ensures any smartphone that might be present can enable its GNSS subsystems and other sensors so they are ready by the time the vehicle ignition is turned on, delivering more complete trip information than would be possible using mobile-only information. In fact, this approach provides valuable pre-trip information about the time between the driver entering the vehicle and the time the vehicle ignition is enabled, information that is not available from aftermarket or professionally-fitted telematics hardware. Measuring the time between driver entry and vehicle start is useful to improve the accuracy of driver identification, in addition to providing insight into the state of mind of the driver before their trip: For example, a driver in a hurry may close the door more abruptly and start the car quicker than the same individual in a calmer state of mind.

The same door opening and closing classifier can be used to help differentiate between a single-occupancy vehicle and multiple-occupancy vehicle. A single-occupancy vehicle typically produces a single door open/close sequence, helping to provide context about each trip without the need to install additional internal occupancy sensors. This information is valuable to assess driving risks based on potential internal occupant interactions, in addition to providing input for automated or semi-automated high-occupancy/tolled lanes involving single or multi-occupant rules.

The device 10 and a system including such a device presents a unique solution to the unsolved problem of traditional beacons or tags being placed or installed incorrectly within a vehicle. In this embodiment of the device part of the system, additional ambient information can be reliably measured including the presence and intensity of precipitation on the windscreen using an infrared rain sensor on the surface in contact with the windscreen. The preferred asymmetrical shape of the device 10 provides intuitive guidance for the driver to install with the flatter side down and a portion of the upper surface in contact with the windscreen 14. A small adhesive area is preferably included in the device 10 to further improve the reliability of the mechanical coupling between the vehicle and device 10.

Additional capabilities made possible as a result of the device shape and self-installation location includes use of low-cost optical sensors as additional cues to classify covered or uncovered vehicle parking locations, ambient lighting conditions throughout each journey, and also use the same sensors to detect the presence of headlights from oncoming traffic. All of these observations of contextual and ambient conditions are useful sources of information to help assess dynamic driver and vehicle risk.

Using the placement of the device 10 between the windscreen and dashboard guided by the shape of the housing enables road network information to be measured using the unique frequency spectrum characteristics produced from a vehicle driving on an asphalt paved surface, an unfinished (gravel) surface, or a concrete surface for example. Similarly, the vehicle movements in response to driving over potholes and raised speed bumps can also be more reliably differentiated due to the mechanical coupling of the device and the vehicle.

A hybrid decision making framework can be employed to classify both road conditions and anomalies. This hybrid approach is important to enable high accuracy classification with limited local resources.

A set of predefined low-level patterns may be recognized within the device and delivered to the server along with additional relevant parameters (vehicle speed, vehicle type, location, and power spectral density). On the server, time sequences of pre-identified low-level patterns and parameters can then be evaluated at a higher level using both historical patterns within the known vehicle, and patterns observed by other vehicles on the same road segments. While information from other vehicles is not required, when it is available, it can help to further improve the accuracy of persistent road surface anomalies such as minor potholes. This decision-making framework can be valuable to ensure driving behaviours are quantified in the context of the underlying road surface conditions, minimizing false-positives for harsh braking events and decoupling vehicle behaviours resulting from driver actions (or inaction) from vehicle behaviours resulting from road surface anomalies.

For example, in the case of a vehicle crossing a rumble strip, the characteristic “rumble” easily identifiable to the driver is also observed by the accelerometer and/or the broad-spectrum microphone within the device as a low-level pattern input into the hybrid decision making framework. Transverse rumble strips are identifiable by similar patterns being generated from multiple vehicles traveling along the same road segment (correlated by location), whereas shoulder and centreline rumble strips are normally identifiable only by vehicles making specific lateral manoeuvres (lane change) when the rumble strip pattern was detected.

The one or more embodiments are described above by way of example only. Many variations are possible without departing from the scope of protection afforded by the appended claims.

1. An information capture device for vehicle monitoring, the device comprising
a. an external housing;
b. at least one internal power supply;
c. at least one communication device; and
d. a broad-spectrum sensing device to capture input information in relation to at least one measurable parameter relating to the vehicle.

2. The information capture device as claimed in claim 1 wherein the broad-spectrum sensing device is configured to capture input information in relation to at least one measurable parameter relating to vehicle dynamics.

3. The information capture device as claimed in claim 1 wherein the broad-spectrum sensing device is configured to capture input information in relation to at least one measurable parameter relating to conditions within the vehicle or outside the vehicle.

4. The information capture device as claimed in claim 1 wherein the broad-spectrum sensing device is configured to capture input information in relation to at least one measurable parameter relating to events occurring within the vehicle or outside the vehicle.

5. The information capture device as claimed in claim 1 wherein at the broad-spectrum sensing device is configured to capture input information in relation to at least one measurable parameter relating to occupant entry to and/or exit from the vehicle.

6. The information capture device as claimed in claim 1 wherein the broad-spectrum sensing device is configured to capture acoustic input information.

7. (canceled)

8. The information capture device as claimed in claim 1 wherein the external housing is provided with one or more optically transparent portions.

9.-11. (canceled)

12. The information capture device as claimed in claim 1 wherein a plurality of sensors is provided within the housing to capture input information in relation to at least one measurable parameter relating to the vehicle.

13. The information capture device as claimed in claim 12 configured to capture input information from each of the plurality of sensors contemporaneously.

14. The information capture device as claimed in claim 13 wherein input information captured contemporaneously from more than one sensor is analysed to cross-check for anomalies.

15. The information capture device as claimed in claim 1 wherein the broad-spectrum sensing device comprises a broad-spectrum microphone to capture acoustic information within the vehicle and/or relating to the vehicle.

16. The information capture device as claimed in claim 1 wherein the broad-spectrum sensing device comprises a broad-spectrum accelerometer.

17. (canceled)

18. The information capture device as claimed in claim 1 wherein the detection of an event occurrence by the broad-spectrum sensing device initialises capture of input information or triggers the storage of previously captured input information.

19. The information capture device as claimed in claim 1 further comprising one or more proximity sensor to detect when a portable computing device is proximate to the device.

20. (canceled)

21. The information capture device as claimed in claim 1 further comprising one or more real-time clock to timestamp captured input information on the device.

22.-24. (canceled)

25. The information capture device as claimed in claim 1 wherein the information capture device captures information at different times and stores captured information from at least one sensor from one or more timesteps before, during, and after an event using at least one circular buffer with at least one configurable duration and at least one configurable timestep frequency.

26.-27. (canceled)

28. The information capture device as claimed in claim 1 wherein the broad-spectrum sensing device captures information in a range of an audible frequency range of between 20 Hz to 20000 Hz.

29.-31. (canceled)

32. The information capture device as claimed in claim 1 wherein the broad-spectrum sensing device is a multi-axis sensor.

33. (canceled)

34. A system for vehicle monitoring, the system comprising the information capture device according to claim 1 and a portable computing device including at least one communication device to receive captured information from the information capture device and at least one information storage device.

35. The system for vehicle monitoring as claimed in claim 34 wherein the information capture device operates in a continuous mode when the portable computing device is within range of the in-vehicle information capture device and in a store and forward mode when the portable computing device is not within range of the information capture device.

36.-37 (canceled)

38. A system for vehicle monitoring comprising the information capture device according to claim 1 and a server associated with at least one communication device to receive captured information from the device and a processor operating at least one software program to analyse the information captured by the information capture device.

39. The system for vehicle monitoring as claimed in claim 34 further comprising a server associated with at least one communication device to receive captured information from the device and a processor operating at least one software program to analyse the information captured by the information capture device.

40. (canceled)

41. The system for vehicle monitoring as claimed in claim 34 wherein frequency domain analysis and pattern recognition algorithms are utilised to identify previously trained patterns of vehicle events based on information captured by the information capture device.

42. (canceled)

43. A method of monitoring a vehicle, the method comprising fixing at least one broad spectrum sensing device relative to the vehicle, capturing information in relation to at least one measurable parameter relating to the vehicle using the at least one broad spectrum sensing device and analysing the captured information to in relation to the at least one measurable parameter to identify occurrence of at least one event in relation to the vehicle.

44. The method as claimed in claim 43 wherein the analysis utilises a learning algorithm to identify at least one event based on the at least one measurable parameter.

45. The method as claimed in claim 43 wherein at least two sensors are fixed relative to the vehicle for capture of information contemporaneously and analysing the contemporaneously captured information.

46. The method as claimed in claim 43 wherein the captured information is analysed to detect events chosen from the group including speech, at least one door opening and/or closing, engine or other mechanical vibration, glass breakage and collision.
